(19) United States
(12) Patent Application Publication
(10) Pub. No.: US 2011/0039186 A1
(43) Pub. Date: Feb. 17, 2011

(54) Disc Type Solid Oxide Fuel Cell

(75) Inventors: Joongmyeon Bae, Daejeon (KR); Seung-Wook Baek, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: KOREA ADVANCED INSTITUTE OF SCIENCE AND TECHNOLOGY, Daejeon (KR)

(21) Appl. No.: 12/693,104

(22) Filed: Jan. 25, 2010

(30) Foreign Application Priority Data
Aug. 14, 2009 (KR) 10-2009-0074939

(51) Int. Cl. H01M 8/10; H01M 8/02

(52) U.S. Cl. 429/495; 429/514

(57) ABSTRACT

Provided is a disc type solid oxide fuel cell; and, more particularly, to a disc type solid oxide fuel cell in which each element is stacked on a supporting member, thereby improving stacking efficiency and also reducing a size of the fuel cell, and in which a unit cell is sinter-bonded with a metal supporter and the metal supporter is welded to a separating plate, thereby improving durability and sealing ability.

### CROSS-REFERENCE(S) TO RELATED APPLICATIONS

The present invention claims priority of Korean Patent Application No. 10-2009-0074939, filed on 14 Aug. 2009, which is incorporated herein by reference.

### BACKGROUND OF THE INVENTION

1. Field of the Invention

The present invention relates to a disc type solid oxide fuel cell; and, more particularly, to a disc type solid oxide fuel cell in which each element is stacked on a supporting member, thereby improving stacking efficiency and also reducing a size of the fuel cell, and in which a unit cell is sinter-bonded with a metal supporter and the metal supporter is welded to a separating plate, thereby improving durability and sealing ability.

2. Description of Related Art

A fuel cell, which is a cell directly converting chemical energy produced by oxidation into electrical energy, is a new next-generation eco-friendly energy technology generating electrical energy from materials abundantly existing on earth, such as hydrogen, oxygen.

In the fuel cell, oxygen is supplied to a cathode and hydrogen is supplied to an anode so as to perform electrochemical reaction in the form of a reverse reaction of electrolysis of water, thereby producing electricity, heat, and water. As a result, the fuel cell produces electrical energy at high efficiency without leading to pollution.

Such a fuel cell has various advantages that it is free from a limitation of Carnot Cycle acting as a limit in a conventional heat engine so that its efficiency is increased above 40%, it discharges only water as the discharge materials as described above so that there is no a risk of pollution, and it does not need mechanically moving parts so that it is compacted and does not generate noise, or the like. Therefore, various technologies and studies associated with the fuel cell have actively been progressed.

Six kinds of fuel cells, such as a phosphoric acid fuel cell (PAFC), a molten carbonate fuel cell (MCFC), a solid oxide fuel cell (SOFC), a polymer electrolyte membrane fuel cell (PEMFC), a direct methanol fuel cell (DMFC), and an alkaline fuel cell (AFC) according to kinds of electrolytes have been put to practical use or has been in contemplation. Features of each fuel cell are arranged in the following table.

| Division | PAFC | MCFC | SOFC | PEMFC | DMFC | AFC |
|---|---|---|---|---|---|---|
| Electrolyte | Phosphoric | Lithium | Zirconia/ | Hydrogen | Hydrogen | Potassium |
| | acid | carbonate/ | ceria | Ion | Ion | hydroxide |
| | | Potassium | | exchange | exchange | |
| | | carbonate | | Membrane | Membrane | |
| Ion | Proton | Carbonate | Oxygen | Proton | Proton | Proton |
| conductor | | ion | ion | | | |
| Operating | 200 | 650 | 500-1000 | <100 | <100 | <100 |
| temperature | | | | | | |
| (° C.) | | | | | | |
| Fuel | Hydrogen | Hydrogen, | Hydrogen, | Hydrogen | Methanol | Hydrogen |
| | | Carbon | Carbon | | | |
| | | monoxide | monoxide, | | | |
| | | | hydrocarbon | | | |
| Fuel raw | City gas, | City gas, | City gas, | Methanol, | Methanol | Hydrogen |
| material | LPG | LPG, Coal | LPG, | methane | | |
| | | | Hydrogen | gasoline, | | |
| | | | | Hydrogen | | |
| Efficiency (%) | 40 | 45 | 45 | 45 | 30 | 40 |
| Output | 100-5000 | 1000-1000000 | 1000-100000 | 1-10000 | 1-100 | 1-100 |
| range (W) | | | | | | |
| Main use | Distributed | Large | Small. | Power for | Portable | Power |
| | generation | scale | Medium, | transportation | power | supply |
| | type | generation | and Large | | supply | for |
| | | | scale | | | Spaceship |
| | | | generation | | | |
| Development | Verification- | Test- | Test- | Test- | Test- | Application |
| stage | commercialization | verification | verification | verification | verificaion | to |
| | | | | | | spaceship |

As appreciated from the table, each fuel cell has various output ranges and uses, etc. so that suitable fuel cells can be selected according to an object. Among them, since the solid oxide fuel cell (SOFC) has advantages in that there is no danger of an exhaustion of an electrolyte because a position of the electrolyte is easily controlled and the position of the electrolyte is fixed and also it has a long life span due to low corrosiveness, as compared to other fuel cells, the effective value of the SOFC is very large in that it is applicable to distributed generation, commerce and home use.

Reviewing the concept view of the operating principle of the SOFC, oxygen is supplied to the cathode and hydrogen is supplied to the anode. At this time, the reaction depends on the following formula.

Anode reaction: 2H₂+2O²⁻→2H₂O+4e⁻

Cathode reaction: O₂+4e⁻→2O²⁻

In the SOFC, typically, yttria-stabilized zirconia (YSZ) is used as the electrolyte, a Ni-YSZ cermet is used as the cathode, a perovskite material is used as the anode and oxygen ions are used as mobile ions.

FIG. 1 is a schematic view of a conventional solid oxide fuel cell (SOFC). The conventional SOFC 1 includes a unit cell 10 having an electrolyte layer 11, an anode 12 and an cathode 13 which are formed at both sides of the electrolyte layer 11; a current collecting member 20 which is provided at both sides of the unit cell 10; and a

separation 30a, 30b in which the unit cell 10 and the current collecting member 20 are provided.

The separation plate 30a, 30b supports the unit cell 10 and the current collecting member 20 and, at the same time, has a supplying passage 31a, 31b for supplying fuel gas and air (oxygen).

Meanwhile, in the SOFC 1, the fuel gas and air has to be flowed through only a predetermined path. If the fuel gas and air are mixed with each other or leaked to an outside, the performance of the cell is considerably deteriorated. Therefore, a high level of sealing technology is required.

However, in the conventional SOFC, a glass-based sealant 40 is used in bonding between the separation plates 30a and 30b and bonding between the unit cell 10 and the separation plates 30a and 30b. (FIG. 1 shows an example that a cathode 13 side of the unit cell 10 is bonded with the upper separation plate 30b using the sealant 40).

However, since the glass-based sealant 40 is easily broken by an external impact, it is difficult to have a sufficient strength. Also, since the glass-based sealant 40 is easily deformed by repeated changes in temperature, it is difficult to obtain a sufficient sealing performance. These problems are major causes for the performance deterioration of the SOFC 1.

Further, the current collecting member 20 is provided between the unit cell 10 and the separation plate 30a, 30b so as to enhance an electrical performance, and formed into a mesh formed of a metal alloy or a noble metal. The current collecting member 20 functions to uniformly supply the fuel gas and air to the unit cell 10. However, sealing ability is deteriorated due to the mesh type current collecting member 20, and current collecting efficiency is also lowered.

Meanwhile, only a signal unit cell module is not sufficient to obtain an enough voltage, and thus it is necessary to increase a surface area of the unit cell 10, or if necessary, multiple unit cells are stacked and then used. However, in this case, it is difficult to satisfy required mechanical strength and enough sealing feature.

### SUMMARY OF THE INVENTION

An embodiment of the present invention is directed to providing a disc type solid oxide fuel cell (SOFC) in which a center portion of each construction element is hollowed, and which is stacked by using a separate supporting member, thereby reducing a size of the fuel cell and facilely stacking the fuel cells.

Another embodiment of the present invention is directed to providing a disc type SOFC in which each construction element has a circular shape in section, and a unit cell is sinter-bonded with a metal supporter, thereby increasing a sealing efficiency and providing a sufficient mechanical strength.

To achieve the object of the present invention, the present invention provides a disc type solid oxide fuel cell (SOFC), including a unit cell 100 which is provided with an electrolyte layer 110, and an anode 120 and a cathode 130 which are formed at both side surfaces of the electrolyte layer 110; a first current collecting member 310 which is provided at one side surface of the unit cell 100; and a separation plate 400 which is provided at the other side surface of the unit cell 100 so as to have a passage 410 through which air or fuel is flowed, wherein the separation plate 400, the unit cell 100 and the first current collecting member 310 are hollowed at center portions thereof, and stacked to be supported by a separate supporting member 500.

Preferably, the disc type SOFC further includes a metal supporter 200 which is provided between the unit cell 100 and the separation plate 400.

Preferably, the separation plate 400, the metal supporter 200, the unit cell 100 and the first current collecting member 310 are repeatedly stacked in plural layers.

Preferably, one of the fuel and air is supplied to the passage 410 of the separation plate 400 through the supporting member 500 and then discharged through the supporting member 500, and the other is supplied from an outside. At this time, the supporting member 500 has first and second paths 510 and 520 formed in a length direction, and the first and second paths 510 and 520 have first and second communicating portion 511 and 512 formed in a transverse direction.

Preferably, the separation plate 400 has inlet and outlet portions 411 and 412 which are connected with the first and second communicating portions 511 and 512 so that the fuel or air introduced through the inlet portion 411 is circulated along the passage 410 and then discharged through the outlet portion 412. And one of the fuel and the air is supplied through the first path 510 and the first communicating portion 511 of the supporting member 500 and the inlet portion of the separation plate 400, and flowed through the passage 410, and then discharged through the outlet portion 412 of the separation plate 400 and the second communication 512 and the second path 520 of the supporting member 500.

Preferably, the separation plate 400, the metal supporter 200, unit cell 100 and the first current collecting member 310 have a circular shape in section.

Preferably, the metal supporter 200 and the unit cell 100 are sinter-bonded by applying a bonding material 600 before stacking the metal supporter 200 and the unit cell 100 and the metal supporter 200 is welded to a side of the passage 410 of the separation plate 400 and a second current collecting member 320 which is provided between the metal supporter 200 and the separation plate 400 is further provided.

Preferably, after the separation plate 400 the metal supporter 200 the unit cell 100 and the first current collecting member 310 are stacked, a hollowed region contacted with the supporting member 500 which is positioned at an upper side of the first current collecting member 310 is sealed by a sealing material 710 and an internally stepped portion 413 is formed at a lower side of the separation plate 400 to be adjacent to the hollowed region, and the disc type SOFC 1000 further including a sealing disc 720.

Preferably, the metal supporter 200 is boned with the anode 120 of the unit cell 100 and the fuel is supplied to the passage 410 of the separation plate 400 through the supporting member 500 and the air is supplied from an outside.

Preferably, the metal supporter 200 has a hollowed portion 210 so that the passage 410 of the separation plate 400 is communicated with the unit cell 100 and the hollowed portion 210 is provided in plural.

### BRIEF DESCRIPTION OF THE DRAWINGS

FIG. 1 is a schematic view of a conventional disc type solid oxide fuel cell (SOFC).

FIGS. 2 to 4 are a perspective view, an exploded perspective view and a cross-sectional perspective view of a SOFC in accordance with the present invention.

FIG. 5 is a view of a metal supporter of the SOFC in accordance with the present invention.

FIG. 6 is a view of a separation plate of the SOFC in accordance with the present invention.

FIG. 7 is a view of a supporting member of the SOFC in accordance with the present invention.

FIG. 8 is a view illustrating a flow of fuel or air in the SOFC in accordance with the present invention.

FIG. 9 is a perspective view showing another SOFC in accordance with the present invention.

FIG. 10 is a perspective view showing yet another SOFC in accordance with the present invention.

FIG. 11 is a schematic view illustrating a method of fabricating the SOFC in accordance with the present invention.

FIGS. 12 and 13 are views illustrating each process in the method of fabricating the SOFC in accordance with the present invention.

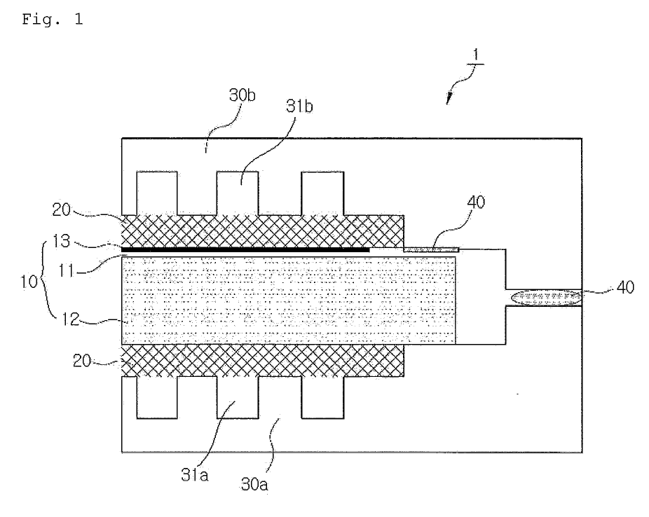

### DETAILED DESCRIPTION OF MAIN ELEMENTS

| | | |
|---|---|---|
| 1000: | disc type solid oxide fuel cell | |
| 100: | unit cell | 110: electrolyte layer |
| 120: | anode | 130: cathode |
| 200: | metal supporter | 210: hollowed portion |
| 310: | first current collecting member | |
| 320: | second current collecting member | |
| 400: | separation plate | 410: passage |
| 411: | inlet portion | 412: outlet portion |
| 413: | stepped portion | |
| 500: | supporting member | 510: first path |
| 511: | first communicating portion | |
| 520: | second path | |
| 521: | second communicating portion | |
| 600: | bonding material | |
| 710: | sealing material | 720: sealing disc |

### DESCRIPTION OF SPECIFIC EMBODIMENTS

The advantages, features and aspects of the invention will become apparent from the following description of the embodiments with reference to the accompanying drawings, which is set forth hereinafter.

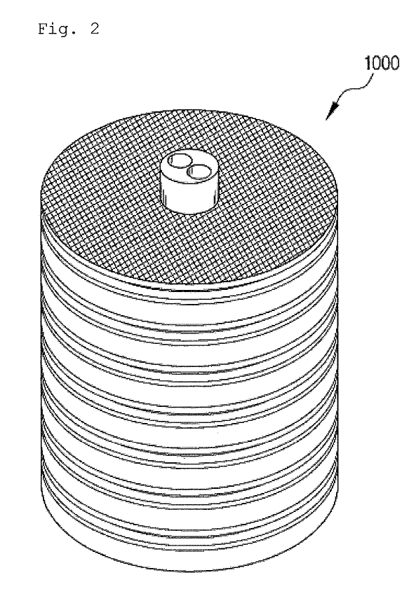

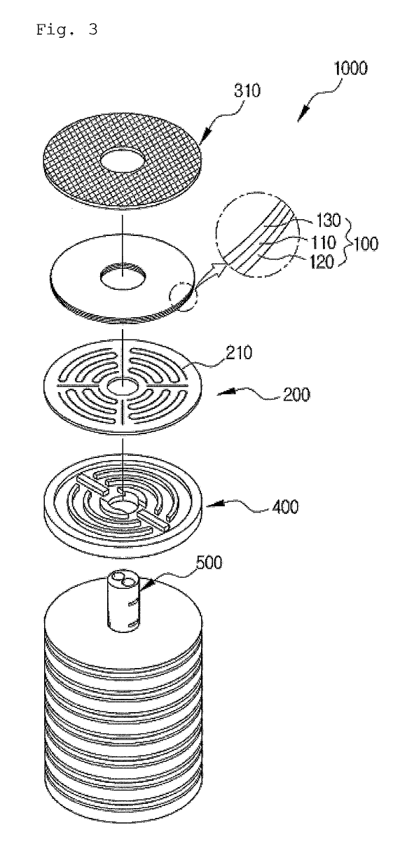

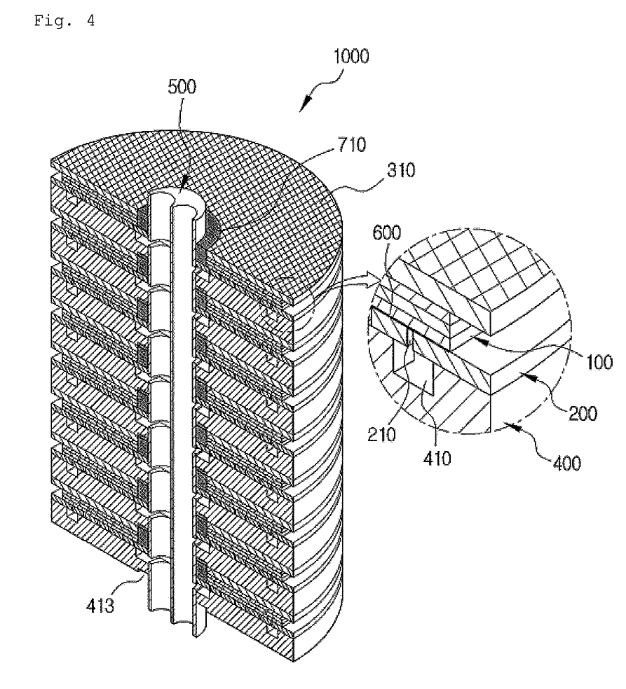

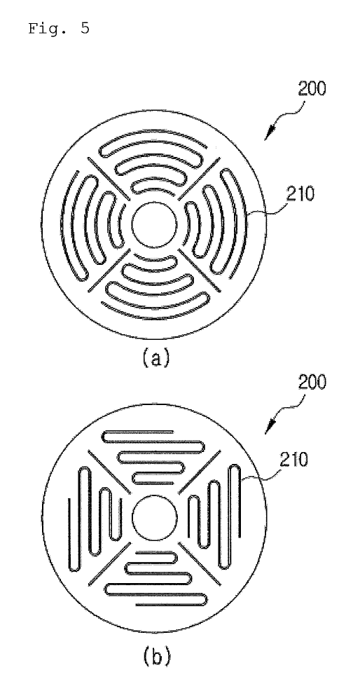

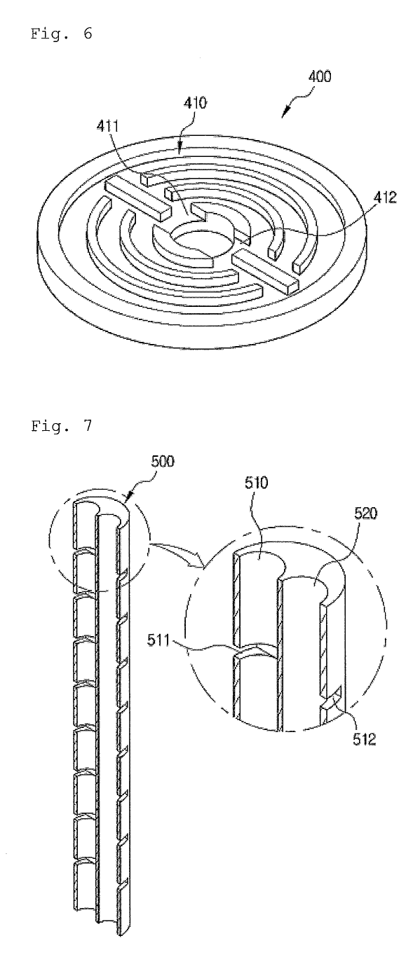

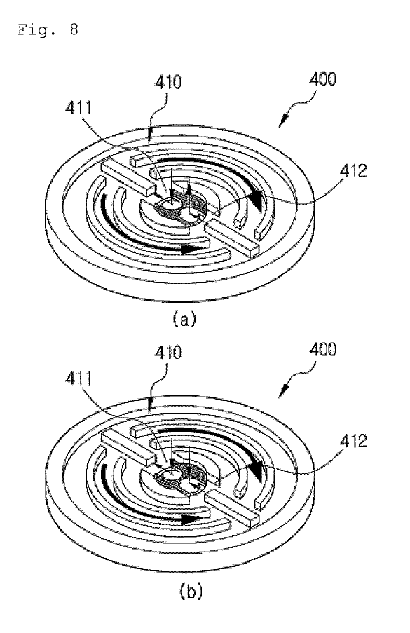

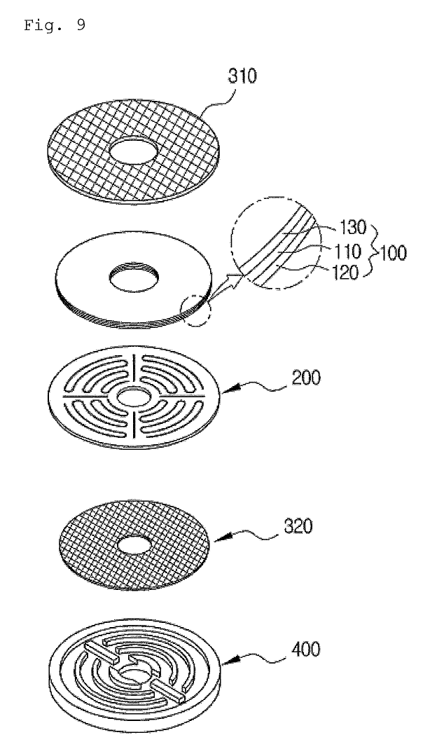

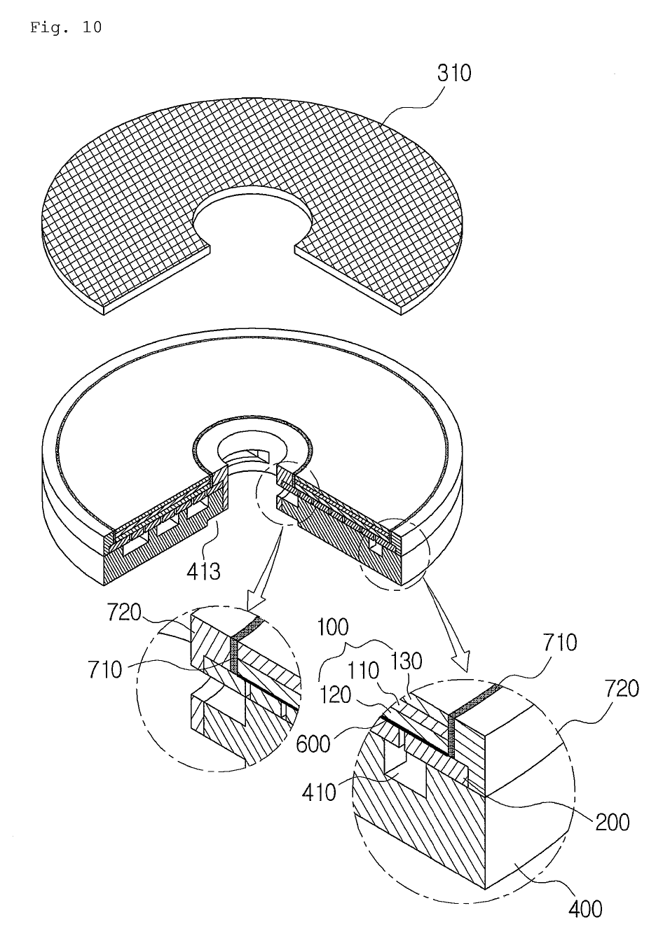

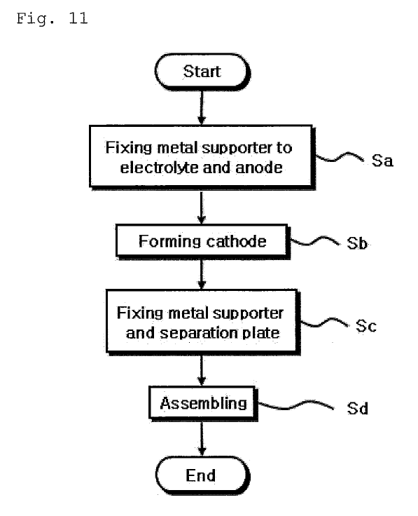

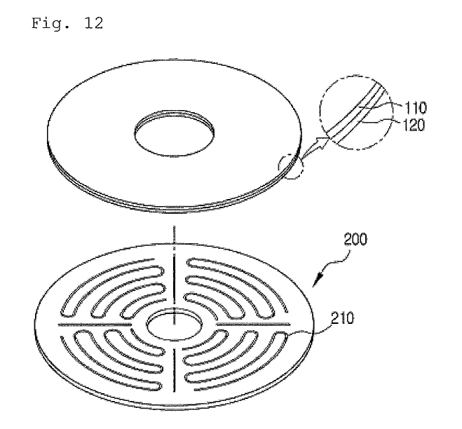

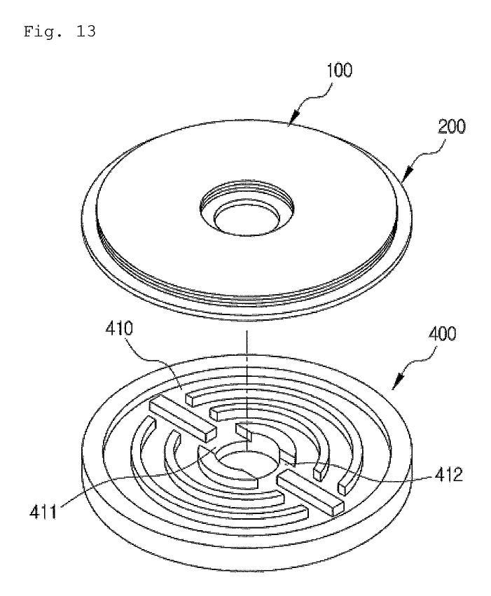

FIGS. 2 to 4 are a perspective view, an exploded perspective view and a cross-sectional perspective view of a disc type solid oxide fuel cell (SOFC) 1000 in accordance with the present invention, FIG. 5 is a view of a metal supporter 200 of the SOFC 1000 in accordance with the present invention, FIG. 6 is a view of a separation plate 400 of the SOFC 1000 in accordance with the present invention, FIG. 7 is a view of a supporting member 500 of the SOFC 1000 in accordance with the present invention, FIG. 8 is a view illustrating a flow of fuel or air in the SOFC 1000 in accordance with the present invention, FIG. 9 is a perspective view showing another SOFC 1000 in accordance with the present invention, FIG. 10 is a perspective view showing yet another SOFC 1000 in accordance with the present invention, FIG. 11 is a schematic view illustrating a method of fabricating the SOFC 1000 in accordance with the present invention, and FIGS. 12 and 13 are views illustrating each process in the method of fabricating the SOFC 1000 in accordance with the present invention.

A disc type SOFC 1000 of the present invention includes a unit cell 100 a first current collecting member 310, a separation plate 400 and a supporting member 500.

The unit cell 100 includes an electrolyte layer 110, and an anode 120 and a cathode 130 which are formed at both sides of the electrolyte layer 110. A center portion of the unit cell 100 is hollowed so that the supporting member 500 is inserted therethrough.

In the drawings, the anode 120 is formed at the side (a lower side of the drawing) contacted with the separation plate 400 and then the electrolyte layer 110 and the cathode 130 are formed in turn in an upper direction of the drawing. However, the present invention is not limited to this example.

A hollowed portion 210 may be provided in plural and formed into various shapes.

The separation plate 400 has a passage 410 at one side thereof, which is contacted with the unit cell 100 so that the air or fuel is flowed through the passage 410.

At this time, in case that the separation plate 400 is contacted with the anode 120 of the unit cell 100 the material flowed through the passage 410 is fuel, and in case that the separation plate 400 is contacted with the cathode 130 of the unit cell 100 the material flowed through the passage 410 is air.

The passage 410 may be formed into various shapes or types. Preferably, the passage 410 is formed so that the fuel or air is uniformly flowed over the entire areas of the unit cell 100.

FIG. 6 shows an example that the passage 410 of the separation plate 400 is divided into two regions so as to form a plurality of circular passages 410. Further, according to the disc type SOFC 1000 of the present invention, the passage 410 may be formed into various shapes or types by controlling a shape of a protrusion in the separation plate 400.

In the disc type SOFC 1000 of the present invention, a metal supporter 200 may be further provided between the unit cell 100 and the separation plate 400.

The drawings show an example including the metal supporter 200.

The metal supporter 200 is provided at one side of the unit cell 100 to support the unit cell 100 and formed into a plate shape so as to increase a current collecting efficiency of the SOFC 1000. Further, the metal supporter 200 is also hollowed at a center portion thereof, and has a hollowed portion 210 so that the fuel or air supplied through the separation plate 400 is supplied to the unit cell 100.

Since one side surface of the metal supporter 200 is bonded with the unit cell 100 and the other side surface thereof is bonded with the separation plate 400 the metal supporter 200 has to have desired mechanical strength and heat resistance sufficient to prevent a deformation upon a bonding process. The metal supporter 200 may be formed of a metal, a metal alloy and the like.

Preferably, the unit cell 100 and the metal supporter 200 are boned with each other. At this time, the unit cell 100 and the metal supporter 200 may be sinter-bonded by providing a bonding material 600 therebetween.

In the sinter-bonding, slurry having porous and conductive characteristics is used as the bonding material 600 so that the fuel or air supplied through the metal supporter 200 is smoothly flowed to the unit cell 100. For example, a cermet in which a ferrite-based metal is mixed with a very small amount of NiO/YSZ may be used.

In the disc type SOFC 1000 of the present invention, since the unit cell 100 and the metal supporter 200 are sinter-bonded with each other using the bonding material 600, it is possible to solve a problem that the sealing or current collecting efficiency is deteriorated due to using of a conventional current collector. Further, it is possible to enhance the mechanical strength and durability of the SOFC 1000.

Furthermore, a temperature of 1000° C. or more is needed in the sinter-bonding, and thus if a bonding surface area is wide, the unit cell 100 may be deformed. However, in the SOFC 1000 of the present invention, since the unit cell 100 and the metal supporter 200 are hollowed at the center portions thereof so as to be inserted onto the supporting member 500, it is possible to minimize the deformation of the unit cell 100 which may be occurred in the sinter-bonding process.

The metal supporter 200 of FIG. 5a has the hollowed portion 210 which is continuously formed at each of four partitioned spaces. For example, the hollowed portion 210 formed at each space is formed into a Z-shape that a part of a circumference thereof is continuously connected so as to be facilely communicated with the passage 410 of the separation plate 400.

Alternatively, the metal supporter 200 of FIG. 5b has the Z-shape hollowed portion 210 which is continuously formed at each of four partitioned spaces to be perpendicular to a diameter of the metal supporter 200.

The hollowed portion 210 of the metal supporter 200 may be formed into various shapes. However, the hollowed portion 210 is formed only within a region bonded with the unit cell 100 so that the fuel or air flowed through the passage 410 of the separation plate 400 is smoothly supplied to the unit cell 100. Preferably, the passage 410 of the separation plate 400 and the hollowed portion 210 of the metal supporter 200 are formed to be up and downwardly connected with each other so that the fuel or air is smoothly supplied to the unit cell 100.

Preferably, the side of the separation plate 400 that the passage 410 is formed, is bonded with the metal supporter 200. The welding may be applied as the bonding method.

Outer circumferences of the separation plate 400 and the metal supporter 200 are welded to each other, thereby further increasing the sealing ability. Of course, the welding with respect to a space (first and second communicating portions 511 and 512 to be described later) through which the fuel or air is introduced to the passage 410 of the separation plate 400 is excluded.

In the present invention, the welding includes brazing as well as laser welding, argon welding and so on.

The disc type SOFC 1000 of the present invention solves a problem that the fuel is leaked through the bonded portion between the metal supporter 200 and the separation plate 400 and thus energy generation efficiency is reduced.

The first current collecting member 310 is provided at the other side of the unit cell 100 (which is not bonded with the metal supporter 200). Preferably, the first current collecting member 310 is formed into a porous or mesh type through which the fuel or air is smoothly supplied to the unit cell 100 from an outside.

In the disc type SOFC 1000 of the present invention, as shown in FIG. 9, a second current collecting member 320 may be further provided between the separation plate 400 and the metal supporter 200 in order to increase the current collecting efficiency. At this time, the separation plate 400 has an internally stepped portion so as to receive the second current collecting member 320.

The supporting member 500 is inserted into the unit cell 100 the metal supporter 200 the first current collecting member 310 and the separation plate 400. The disc type SOFC 1000 of the present invention is manufactured by repeatedly stacking the separation plate 400 the metal supporter 200 the unit cell 100 and the first current collecting member 310 in turn.

At this time, one of the fuel and the air supplied to the unit cell 100 is supplied through the supporting member 500 to the passage 410 of the separation plate 400 and then discharged through the supporting member 500, and the other one is supplied from an outside.

In other words, the supporting member 500 functions to support the separation plate 400 the metal supporter 200 the unit cell 100 and the first current collecting member 310 and also functions as a supplying path through which the fuel or air is supplied to the separation plate 400. The supporting member 500 of FIG. 7 has first and second paths 510 and 520 formed in a length direction. The first and second paths 510 and 520 have first and second communicating portion 511 and 512 formed in a transverse direction.

The separation plate 400 has inlet and outlet portions 411 and 412 which are connected with the first and second communicating portions 511 and 512 in order to introduce the fuel or air.

The inlet and outlet portions 411 and 412 are formed into an open type, and the open type inlet and outlet portions 411 and 412 have to be maintained even when welding the metal supporter 200 and the separation plate 400.

Hereinafter, the flow of the fuel or air through the passage 410 of the separation plate 400 of the disc type SOFC of the present invention will be described. The fuel or air is flowed through the first path 510 in a length direction and moved to an inner side of the passage 410 of the separation plate 400 through the first communicating portion 511 and the inlet portion 411 so as to be circulated through the passage 410, and then discharged to the second path 520 through the outlet portion 412 and the second communicating portion 512.

FIG. 8 shows an example of the flow of the fuel or air circulating in the passage 410 of the separation plate 400. More detailedly, in FIG. 8a, the fuel or air is flowed from an upper side to a lower side through the first path 510, and moved in the transverse direction through the first communicating portion 511 and the inlet portion 411, and divided into left and right passages 410, and then moved to the second passage 520 through the outlet portion 412 and the second communicating portion 512, and moved from the lower side to the upper side through the second path 520.

In FIG. 8b, the fuel or air is flowed in the same manner as in FIG. 8a, but the fuel or air in the second path 520 is flowed reversely (from the upper side to the lower side).

According to the disc type SOFC 1000 of the present invention, the fuel or air may be flowed to be symmetrical in up and down and left and right directions.

Since the separation plate 400 has to be fixed so that the inlet and outlet portions 411 and 412 are communicated with the first and second communicating portions 511 and 512 of the supporting member 500, there may be provided a height forming member (not shown) for deciding an initial stacking position.

The height forming member may be formed into a bolt shape that a screw thread is formed at an inner surface thereof, and an outer surface of the supporting member 500 may be formed to be corresponding to the inner surface of the height forming member.

The height forming member may have various shapes so as to decide a position thereof at a lower side, and may be fixed by its own weight. Alternatively, other member having the same shape as the bolt type height forming member may be coupled to the upper supporting member 500.

Further, in the disc type SOFC 1000 of the present invention, after each construction element (the separation plate 400 the metal supporter 200 the unit cell 100 and the first current collecting member 310) is stacked, the separation plate 400 the metal supporter 200 the unit cell 100 and the first current collecting member 310 are stacked before stacking of other construction element. Preferably, a hollowed region contacted with the supporting member 500 which is positioned at an upper side of the first current collecting member 310 is sealed by a sealing material.

Therefore, it is possible to increase the sealing ability and thus prevent the fuel and the air from being mixed with each other, and also to increase the energy generation efficiency.

Preferably, in order to receive a volume of a sealing material 710 an internally stepped portion 413 is formed at a lower side of the separation plate 400 to be adjacent to the hollowed region.

As shown in FIG. 10, in the disc type SOFC 1000 of the present invention, a sealing disc 720 may be further provided at the sealed portion.

In FIG. 10, the sealing disc 720 is provided at two places so as to enclose a hollowed center region and an outer circumference.

The sealing disc 720 may be formed into various shapes or types. The sealing disc 720 provided at the hollowed center region has a stepped inner surface so as to enclose the unit cell 100 the metal supporter 200 and the separation plate 400. Herein, the sealing disc 720 is formed so as not to block the passage 410 of the separation plate 400.

In order to enhance the sealing ability of the sealing disc 720, the sealing material 710 may be further provided between the sealing disc 720 and the unit cell 100.

FIG. 10 shows an example that the sealing disc 720 formed at the outer circumference encloses the unit cell 100 and the metal supporter 200 wherein the sealing disc 720 is provided at each of the center region and the outer circumference, and the sealing material 710 is provided between the sealing disc 720 and the unit cell 100.

As shown in FIG. 10, the sealing disc 720 formed at the center region and the outer circumference may be formed into a plate type ring-shaped member according to shapes of the unit cell 100 the metal supporter 200 and the separation plate 400. Also, the sealing disc 720 may be provided at one of the center region and the outer circumference.

Preferably, the separation plate 400 the metal supporter 200 the unit cell 100 and the first current collecting member 310 have a circular shape in section, respectively, and this shape allows the stacking to be facile and also allows the fuel or air supplied through the supporting member 500 to be smoothly flowed over the entire region.

According to the present invention as described above, it is possible to facilely design the flow the fuel or gas and simplify the structure thereof, thereby making the stacking easy.

A method of fabricating the disc type SOFC 1000 of the present invention includes a step Sa of fixing the metal supporter 200 to the electrolyte layer 110 and the anode 120; a step Sb of forming the cathode 130; a step Sc of fixing the metal supporter 200 and the separation plate 400; and an assembling step Sd.

The method of fabricating the disc type SOFC 1000 of the present invention also includes characteristic of each construction element of the disc type SOFC 1000 as described above.

In the step Sa of fixing the metal supporter 200 to the electrolyte layer 110 and the anode 120, the metal supporter 200 is fixedly bonded to an anode 120 side of the electrolyte layer 110 and the anode 120. At this time, the anode 120 side and the metal supporter 200 may be sinter-bonded using the bonding material 600 (referring to FIG. 12).

In the step Sb of forming the cathode 130, the cathode 130 is formed at an electrolyte side of the electrolyte layer 110 and the anode 120 in which the metal supporter 200 is fixed to the anode 120 side.

In the step Sc of fixing the metal supporter 200 and the separation plate 400 the separation plate 400 having the passage 410 through which the air or fuel is flowed is fixed to one side of the metal supporter 200 in which the unit cell 100 is fixed to the other side. Herein, the welding is performed except the space (the inlet and outlet portions 411 and 412) of the separation plate 400 through which the air or fuel is flowed. (referring to FIG. 13).

FIG. 11 shows an example that the cathode 130 is formed after the metal supporter 200 is fixed, and the metal supporter 200 and the separation plate 400 are fixed in turn. However, in the method of manufacturing the disc type SOFC 1000 according to the present invention, the unit cell 100 may be fixed to the metal supporter 200 after the metal supporter 200 and the separation plate 400 are fixed to each other.

In the assembling step Sd, the first current collecting member 310 and an assembly of the unit cell 100 the metal supporter 200 and the separation plate 400 are stacked in plural layers by the supporting member 500. After the first current collecting member 310 and the assembly of the unit cell 100 the metal supporter 200 and the separation plate 400 are stacked in one layer, the hollowed region contacted with the supporting member 500 which is positioned at the upper side of the first current collecting member 310 may be sealed by the sealing material 710.

In other words, the sealing is performed after the first current collecting member 310 and the assembly of the unit cell 100 the metal supporter 200 and the separation plate 400 are stacked, and then the stacking and sealing are repeated.

In the disc type SOFC 1000 of the present invention as described above, since the construction elements are previously bonded to each other, it is possible to simplify the stacking process and increase the sealing efficiency.

Further, since each construction element is hollowed at its center portion and supported by the separate supporting member, it is possible to facilitate the stacking, minimize a size of the fuel cell and also stably enhance the energy generation efficiency.

Further, since each construction element is formed to have a circular shape in section and the unit cell and the metal supporter are sinter-bonded, it is possible to increase the sealing efficiency and minimize the deformation of the cell. Also since the metal supporter is bonded to the separation plate, it is possible to provide the sufficient mechanical strength.

Furthermore, since one of the fuel and the air is flowed to the passage of the separation plate through the supporting member and then discharged through the supporting member, and the other is supplied from the outside, it is possible to facilely supply the fuel or air and simplify the structure thereof.

While the present invention has been described with respect to the specific embodiments, it will be apparent to those skilled in the art that various changes and modifications may be made without departing from the spirit and scope of the invention as defined in the following claims.

What is claimed is:

1. A disc type solid oxide fuel cell (SOFC), comprising:
a unit cell which is provided with an electrolyte layer, and an anode and a cathode which are formed at both side surfaces of the electrolyte layer;
a first current collecting member which is provided at one side surface of the unit cell; and
a separation plate which is provided at the other side surface of the unit cell so as to have a passage through which air or fuel is flowed,
wherein the separation plate, the unit cell and the first current collecting member are hollowed at center portions thereof, and stacked to be supported by a separate supporting member.

2. The disc type SOFC of claim 1, further comprising a metal supporter which is provided between the unit cell and the separation plate.

3. The disc type SOFC of claim 2, wherein the separation plate, the metal supporter, the unit cell and the first current collecting member are repeatedly stacked in plural layers.

4. The disc type SOFC of claim 3, wherein one of the fuel and air is supplied to the passage of the separation plate through the supporting member and then discharged through the supporting member, and the other is supplied from an outside.

5. The disc type SOFC of claim 4, wherein the supporting member has first and second paths formed in a length direction, and the first and second paths have first and second communicating portion formed in a transverse direction.

6. The disc type SOFC of claim 5, wherein the separation plate has inlet and outlet portions which are connected with the first and second communicating portions so that the fuel or air introduced through the inlet portion is circulated along the passage and then discharged through the outlet portion.

7. The disc type SOFC of claim 6, wherein one of the fuel and the air is supplied through the first path and the first communicating portion of the supporting member and the inlet portion of the separation plate, and flowed through the passage, and then discharged through the outlet portion of the separation plate and the second communication and the second path of the supporting member.

8. The disc type SOFC of claim 2, wherein the separation plate, the metal supporter, unit cell and the first current collecting member have a circular shape in section.

9. The disc type SOFC of claim 2, wherein the metal supporter and the unit cell are sinter-bonded by applying a bonding material before stacking the metal supporter and the unit cell.

10. The disc type SOFC of claim 2, wherein the metal supporter is welded to a side of the passage of the separation plate.

11. The disc type SOFC of claim 10, further comprising a second current collecting member which is provided between the metal supporter and the separation plate.

12. The disc type SOFC of claim 9, wherein, after the separation plate, the metal supporter, the unit cell and the first current collecting member are stacked, a hollowed region contacted with the supporting member which is positioned at an upper side of the first current collecting member is sealed by a sealing material.

13. The disc type SOFC of claim 12, wherein an internally stepped portion is formed at a lower side of the separation plate to be adjacent to the hollowed region.

14. The disc type SOFC of claim 13, further comprising a sealing disc.

15. The disc type SOFC of claim 2, wherein the metal supporter is boned with the anode of the unit cell, and the fuel is supplied to the passage of the separation plate through the supporting member and the air is supplied from an outside.

16. The disc type SOFC of claim 2, wherein the metal supporter has a hollowed portion so that the passage of the separation plate is communicated with the unit cell.

17. The disc type SOFC of claim 16, wherein the hollowed portion is provided in plural.
